(19) United States
(12) Patent Application Publication
(10) Pub. No.: US 2002/0120539 A1
(43) Pub. Date: Aug. 29, 2002

(54) Method and system for distributing charitable donations at a point of sale to qualified donees

(76) Inventor: Cynthia L. Price, Brooklyn, NY (US)

Correspondence Address: BROWN, RAYSMAN, MILLSTEIN, FELDER & STEINER LLP, 900 THIRD AVENUE, NEW YORK, NY, 10022, US

(21) Appl. No.: 09/989,709

(22) Filed: Nov. 20, 2001

Related U.S. Application Data
(60) Provisional application No. 60/252,151, filed on Nov. 20, 2000.

(51) Int. Cl. G06F 17/60

(52) U.S. Cl. 705/35

(57) ABSTRACT

This invention provides methods and systems for distributing charitable donations at the point of sale to qualified donees in the manner specified by the donor, comprising at least one charitable donation to a charitable organization, a charitable subscription agreement specifying the manner in which the donation will be distributed, transmitting the subscription agreement to retailers for distribution at the point of sale. At the retail level, retailer determines if the customer is a qualified donee to receive the charitable donation. If the customer is a qualified donee, the products or services presented are verified to determine if there exist any applicable charitable donations. If there are applicable charitable donations, the charitable donation are applied in the form of purchase credits toward the purchase of the verified products or services in accordance with at least one subscription agreement.

### CROSS REFERENCE TO RELATED APPLICATIONS

This application claims priority of Provisional Application No. 60/252,151, entitled “Cause Related Marketing Method and System for Collecting, Distributing and Tracking Donations made to Public Charities and Foundations for the Benefit of Food Stamp and WIC Program Recipients,” filed Nov. 20, 2000, which application is hereby incorporated herein by reference in its entirety.

### BACKGROUND OF THE INVENTION

The invention generally relates to methods and systems for distributing charitable donations. More particularly, the present invention provides methods and systems for collecting charitable donations from a donor, distributing at a point of sale the charitable donations to qualified donees in the form of purchase credits in the manner specified by the donor, tracking the distribution of charitable donations, and generating records of the charitable distributions for tax reporting purposes.

Cause Related Marketing (“CRM”) is a strategic positioning and marketing discipline, which links a company and its products to a social cause or issue. Using CRM, companies create relationships with key stakeholders, enhance brand equity, and differentiate similar products in a competitive marketplace, while providing discrete benefits to promote social programs or particular charitable causes. Accordingly, CRM is a tool for addressing the social issues of the day by providing resources and funding, while at the same time addressing business-marketing objectives. CRM programs are often public-private partnerships wherein a charitable organization collects money from parties for the dual purposes of assisting qualified donees and promoting certain products.

An example of a CRM-driven program is the Hormel® CURE 81® Gift Certificate Program in which The Kroger Company (a supermarket chain) and Hormel® Foods (a food manufacturer) donated gift certificates for nearly 12,000 Hormel® CURE 81® hams to non-profit organizations. In the Kroger-Hormel® promotion, the volume of purchases made by Kroger customers of Hormel® products determined the number of gift certificates that Hormel ultimately gave to non-profit organizations. These gift certificates were then given by the non-profit organizations to charitable donees to claim a Hormel® ham in participating Kroger stores. Thus, by committing to donate Hormelg ham gift certificates to a charity based upon the volume Hormel® Foods purchases in Kroger stores, Kroger and Hormel® Foods, Inc. effectively linked the “cause” of reducing the “food insecurity” of indigent persons with the commercial purpose of selling certain products through specific retailers.

Another example of CRM was the 1996 Fanner's Market Coupon Program for Elders in which food coupons were distributed through the Massachusetts Executive Office of Health and Human Services in conjunction with Bristol Elder Services to elderly persons. In this program, elderly residents of certain areas of Massachusetts who receive Food Stamps and/or certain other Federal government benefits received coupons for the purchase of fresh produce at local farmer's markets.

Although CRM programs are not new, there is no automated means for distributing charitable donations to qualified beneficiaries at the point of sale in the manner in which the donor specifies. Further, there is no automated means for donors to track their donations and to generate reports related to their donations.

Generally, eliminating food insecurity in the United States is the charter the U.S. Department of Agriculture's (“USDA's”) Food Stamp Program (the “FSP”). The FSP is the nation's cornerstone federal food assistance program for low-income Americans. As the first line of defense against hunger, the FSP provides monthly benefits to ensure that poor and hungry persons and families obtain an adequate and nutritious diet. In addition, the USDA also manages the Special Supplemental Nutrition Program for Women, Infant and Children (“WIC”), which is a program that addresses the special needs of at-risk, low-income pregnant, breast-feeding and postpartum women, infants and children by providing them with “prescribed” supplemental food packages targeted to the dietary needs of the individual participants.

The FSP program operates in all 50 States, the District of Columbia, and the U.S. Virgin Islands. Although the program is authorized, appropriated, and regulated under federal jurisdiction, each of the individual States and the District of Columbia administers the program within the respective States. The individual States issue FSP and WIC applications, operate the application process, maintain recipient certification, and dispense benefits to enrollees. To participate in the program, an applicant must meet financial eligibility and resource requirements that are geared to federal poverty guidelines as determined and verified through the FSP and WIC application processes. The USDA's FSP and WIC programs historically have operated by the delivery of paper-based food stamp coupons or WIC vouchers to program participants who used these documents to purchase eligible and prescribed food items at participating retailers.

Currently, both the Food Stamp and WIC programs are migrating toward Electronic Benefit Transfer (“EBT”) cards, in which program benefits electronically are delivered to program participants at the point-of-sale in retailer locations. These EBT cards are currently issued on debit and “smart card” payment distribution and processing platforms that are managed by third party bank clearinghouses. The selection of both the payment distribution and processing platform and the bank or other institution that deliver and process Food Stamp and WIC program benefits is the decision of individual States.

States and U.S. territories are required by federal law to convert to the EBT system; as of this writing, the conversion is not complete. As a result, paper-based Food Stamp coupons and WIC voucher transactions exist concurrently with EBT-based transactions. As a practical matter, the real difference is that in the paper-based environment, retailers and their checkout clerks are tasked with visual verification and physical storage of the payment media. Wherein, in the EBT environment, the retailer can rely upon the customer's “swiping” of his/her EBT card through the magnetic or “smart” card reader and input of an associated personal identification number (“PIN”) on an attached keypad to ensure authenticity of the program beneficiary and availability of sufficient funds to pay for the Instant transaction. EBT-based transactions enable both retailers and the U.S. government to reduce fraudulent redemption of paper-based benefits.

FSP recipients receive as little as ten dollars ($10.00) and an average of seventy-one dollars ($71.00) per month from the FSP. The amount of money disbursed is determined by calculating the difference between the estimated cost of basic food needs for that household, and the amount the household is able to spend on food. However, the USDA's own studies and statistics show that only those under the age of two can subsist on $71 or less per month which requires most households to supplement their Food Stamps and other benefits with cash. In addition, studies have found that some 12 million people who are eligible for these benefits do not receive them.

In addition, recognizing the need for families to have a vehicle and to reduce the cost of housing, on Oct. 28, 2000, President Clinton signed into law the FY 2001 Agriculture Appropriations Conference Report (H. Rcpt. 106-948), Kennedy-Specter/Walsh Hunger Relief Act (S. 1805, H. R. 3192), which, among other things, improves vehicle value and shelter deduction rules for the FSP and is estimated to provide a $1.6 billion increase in food stamp benefits over five years, increase benefits for hard-pressed families, and add new families to the program.

Even though the U.S. government has taken considerable steps to eliminate food insecurity by establishing the FSP and WIC programs and augmenting those programs with subsequent legislation such as the Kennedy-Specter/Walsh Hunger Relief Act, the amount of money distributed to individual recipients in Food Stamp or WIC stamps alone or in combination is insufficient to eliminate food insecurity for recipients. There is, therefore, a need to increase the purchasing power of Food Stamp or WIC stamp recipients, thereby reducing the level of food insecurity for these recipients.

In 1999, Americans collectively gave $190 billion in charitable gifts, the tax-deductibility and amount of which are subject to rigid requirements by the Internal Revenue Service (I.R.S.). Only certain donations and expenses of cash or assets to qualified organizations are tax deductible, and the I.R.S. imposes strict limits on charitable contributions. For example, donations of less than $250 must be documented by a cancelled check, receipt, or other reliable written record. A contribution of $250 or more must be acknowledged in writing by the organization or with certain payroll deduction records. Furthermore, documentation of non-cash contributions grows progressively more rigorous as gifts exceed $250, $500, and $5,000, and non-cash gifts of more than $5,000 generally require a qualified appraisal. A donor taxpayer will not be entitled to a deduction for any charitable contribution of $250 or more unless the donor has “contemporaneous” written substantiation from the charity. This provision does not place an information-reporting duty only on charities. Where an acknowledgment is required, the donor is responsible to obtain said acknowledgment from the charity and keep it with the donor's personal records.

There is thus generally a need for a mechanism whereby donors may track their charitable donations and generate reports associated with their respective charitable donations sufficient to satisfy I.R.S. reporting requirements.

Manufacturers typically distribute purchase credits to consumers in the form of paper coupons. The traditional distribution method is to insert the paper coupons in newspapers or magazines. Thus, a shopper desiring the coupons is required to purchase the newspapers or magazines that contain coupons or obtain coupons from circulated fliers. It is estimated that less than 2% of coupons distributed in this fashion are actually redeemed by customers.

In addition to the traditional coupon distribution method, automated coupon distribution systems have been produced. These systems print paper coupons at the point of sale. Catalina Marketing International, Inc., (“Catalina”), for instance, produces coupon dispensing systems. Description of the hardware and methods utilized by Catalina appear in U.S. Pat. Nos. 6,282,516 entitled “Process, System and Computer Readable Medium for In-Store Printing of Discount Coupons and/or other Purchasing Incentives in Various Departments Within a Retail Store”; U.S. Pat. No. 6,278,976 entitled “System and Apparatus for Dispensing Coupons Having Selectively Printed Borders”; and U.S. Pat. No. 5,832,457 entitled “Method and Apparatus for Dispensing Coupons.” These patents are hereby incorporated by reference herein in their entireties. These distribution systems generally produce coupons at the point of service in response to the shopping history of the customer. These systems, however, do not provide means to selectively distribute charitable donations to qualified donees. Similarly, there are no tracking and reporting provisions for charitable donations.

### SUMMARY OF THE INVENTION

It is an object of this invention to provide automated means for distributing charitable donations to qualified donees at the point of sale in the manner in which a donor specifies.

It is further an object of this invention to reduce the level of food insecurity of qualified donees by delivering credits to be applied toward the purchase of products or services at the point of sale.

It is further an object of this invention to provide automated means for tracking charitable donations distributed at the point of sale and means for generating reports associated with charitable donations sufficient to satisfy I.R.S. reporting requirements.

This invention provides methods and systems for distributing charitable donations at the point of sale to qualified donees in the manner specified by the donor. In one embodiment, a process begins with a donor making at least one charitable donation to a charitable organization. The donor and the charitable organization will typically enter into an agreement, such as a charitable subscription agreement, specifying the manner in which the donation will be distributed. The subscription agreement may then be reduced into a computer recognizable format and transmitted to participating retailers for implementation, e.g., distribution at the point of sale. At the retail level, a customer produces goods or services for payment to the retailer.

The retailer then determines if the customer is a qualified donee to receive the charitable donation according to at least one charitable subscription agreement. If the customer is a qualified donee, the products or services presented are verified to determine if there exist any applicable charitable donations according to at least one subscription agreement, and further whether the donations from this charitable donation are still available. If there are applicable charitable donations, the charitable donations are applied in the form of purchase credits toward the purchase of the verified products or services in accordance with at least one subscription agreement.

The methods and systems further provide means for retailers to compile data associated with charitable distributions and means to generate invoices for collection of distributed purchase credits. The methods and systems also provide means for donors to track their charitable donations and to means for them to generate reports associated with their respective charitable donations sufficient to satisfy I.R.S. reporting requirements. Optionally, the methods and systems may include a means for donors or charitable organizations to communicate details of charitable donations with qualified donees.

### BRIEF DESCRIPTION OF THE DRAWINGS

FIG. 1 depicts a diagrammatic representation of an embodiment of the method of distributing charitable donations at a point of service.

FIG. 2 depicts a diagrammatic representation of another embodiment of the method of distributing charitable donations at a point of service.

FIG. 3 depicts an embodiment of a system for distributing charitable donations to qualified donees at a point of service.

### DETAILED DESCRIPTION OF THE PREFERRED EMBODIMENTS

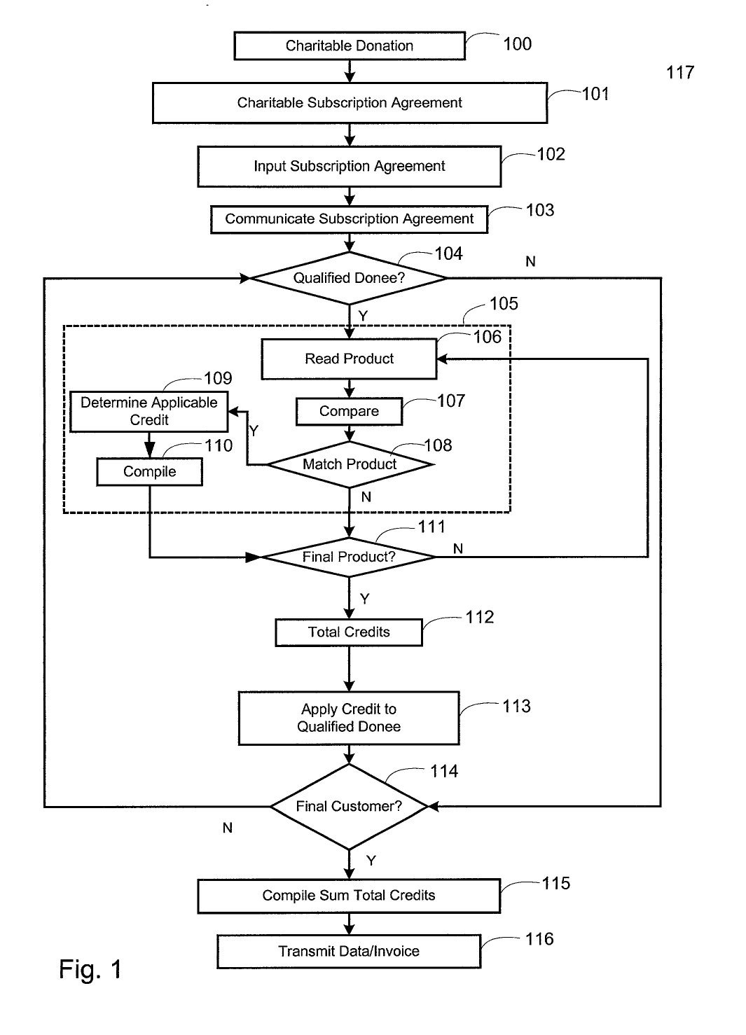

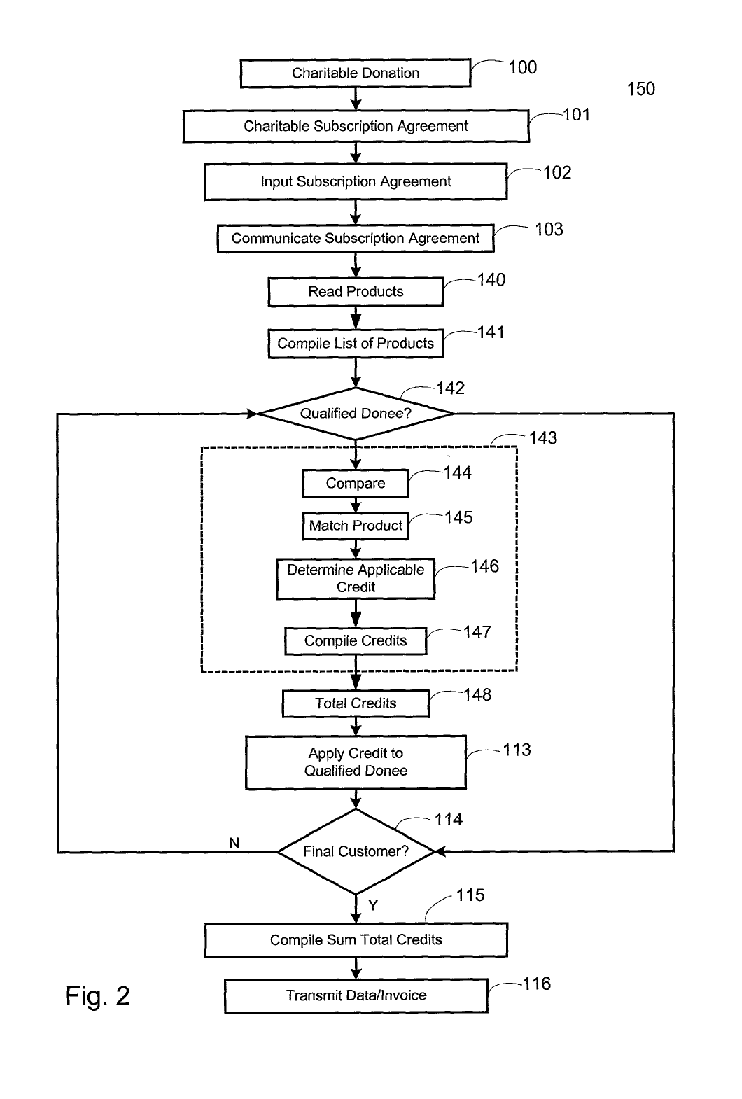

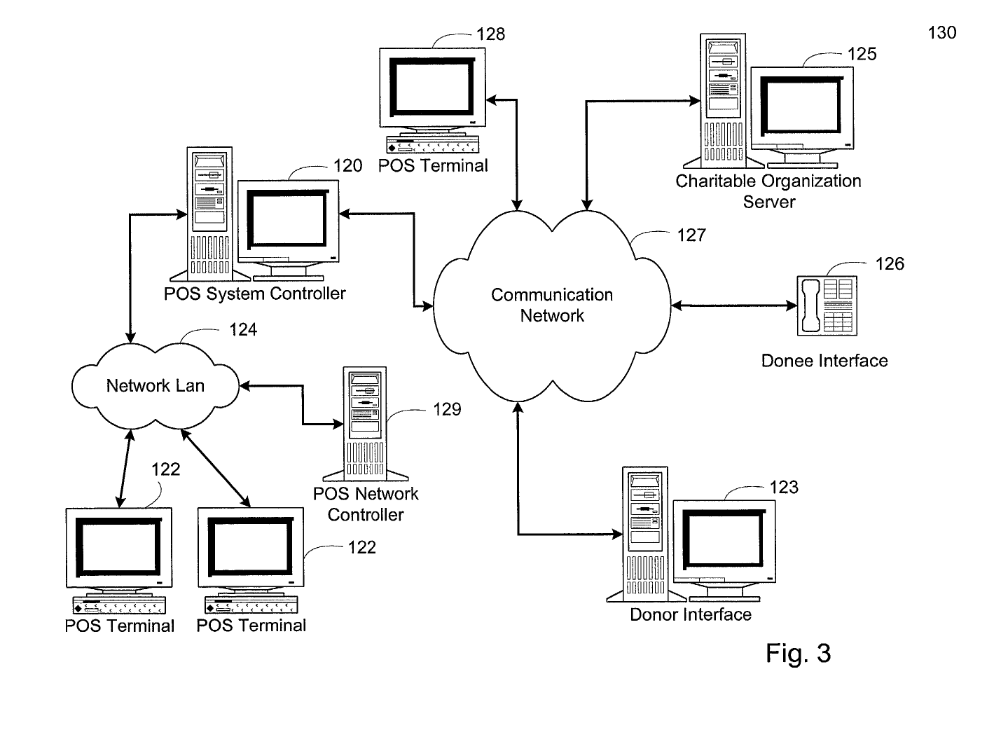

This invention provides method and systems for distributing charitable donations at the point of sale to qualified donees in the manner specified by the donor. FIG. 1 depicts an embodiment of the method to distribute charitable donations to qualified donees at the point of sale (117). FIG. 2 depicts a second embodiment of the method to distribute charitable donations to qualified donees at the point of sale (150). FIG. 3 depicts an embodiment of a system to distribute charitable donations to qualified donees at the point of sale (130).

The methods of one embodiment of the present invention, as illustrated in FIG. 1, begins with at least one Charitable Donation (100). It is anticipated that Charitable Donations (100) may be made directly to a charitable organization or to any number of intermediary organizations. Charitable Donation (100) shall be construed broadly to include all forms of donations. The Charitable Donation (100) for instance may originate from a donor in the course of a CRM program or from individual donors in general. The Charitable Donation (100) itself may be made in cash, by check or money order, by electronic funds transfer (“EFT”) or by credit card. The details of Charitable Donations (100) will typically appear in corresponding Charitable Subscription Agreements (101). If for instance a Charitable Donation (100) is made in the course of a CRM program, the donor will dictate the manner in which the Charitable Donation (100) will be distributed. If instead Charitable Donations (100) are made from individual donors, the charitable organization will specify the details of the distribution.

The terms of the Subscription Agreement (101) generally address the manner in which the Charitable Donation (100) will be distributed. The terms may include a definition of the class of beneficiaries to be qualified as donees to receive the charitable distribution, the size of the charitable distribution for each qualified donee, a description of the products the charitable distribution will apply towards, the form of the purchase credits, etc. A Subscription Agreement (101), for example, may be created between a donor and a charitable organization in connection with a CRM program. In that instance, the donor will generally specify the manner in which the Charitable Donation (100) will be distributed. The donor would specify the class of beneficiaries to receive the donation, such as Food Stamp or WIC stamp participants, or for instance a class of individuals designated for disaster relief. Further, the donor will specify the size of the charitable distribution in the form of purchase credits for each qualified donee. The size can be described as a fixed cash discount, a fixed percentage discount, or a sliding discount according to a specified factor, such as for instance sales of the donor's products in the previous month, or a combination thereof. The donor may specify that the purchase credits be distributed in the form of paper coupons, electronic discounts, or beneficiary cards. The paper coupons may be mailed directly to targeted donees or printed for the targeted donees at the point of sale and the electronic discounts may be communicated to retailers for point of sale distribution. The beneficiary cards may be mailed directly to targeted donees and be a means for identifying the donee at the point of sale for distribution of the electronic discounts. Alternatively, the beneficiary card may be a debit style card containing subscription information, such as the class of donee, the products to receive the purchase credit, the size of the purchase credits, etc. Typically, the donor will specify for the purchase credits to be applied toward the purchase of the donor's products or services, and will specify vesting and the expiration dates for those credits. In another example, a Subscription Agreement (101) may be created by a charitable organization toward a targeted cause, whereby individual donors contribute toward the particular targeted cause. In that instance, the charitable organization specifies the distribution details.

Thereafter, the Subscription Agreement (101) is Input (102) into the System (130) for implementation at the retail level. The Input (102) will typically occur with the charitable organization, whereby the details of the Subscription Agreements (101) are reduced into a computer recognizable format, such as algorithms, tables, etc., and placed onto the Charitable Organization Server (125). The Subscription Agreement (101) is then Communicated (103) to retailers for implementation. The Communication (103), i.e., the transfer of information from the Charitable Organization Server (125) to the POS Terminals (128) and/or the POS System Controller (120), may occur at predetermined intervals, such as daily or weekly. Alternatively, the information may be transferred in real time as soon as the Subscription Agreement (101) is Input (102) into the System (130).

Once the details of the Subscription Agreements (101) have been Communicated (103), retailers will distribute the charitable donations in accordance with the Subscription Agreements (101). In the retail environment, customers will generally produce goods or services at POS Terminals (122) or (128) for purchase. In one embodiment, the retailer will first determine whether the customer is a Qualified Donee (104) in accordance with at least one Subscription Agreement (101). The customer, for instance, may be a qualified donee if the customer is a Food Stamp or WIC Stamp recipient, or otherwise in a class of individuals targeted by the charitable organization to receive charitable distributions in relation to a specified charitable cause. The triggering event may be by entering the method of payment at the POS Terminals (122) or (128), such as Food Stamps, WIC stamps, an EBT card, or a debit card or paper coupon issued by the charitable organization in accordance with at least one subscription agreement. Alternatively, the trigger may be by entering other identifying data into the POS Terminals (122) or (128), such as a name, social security number, address, zip code, telephone number area code, or a signal indicating that the customer produced a particular form of identification such as a beneficiary card. The beneficiary card may be one issued by the States as part of the Food or WIC Stamp program, such as the EBT card, or one issued by the charitable organization for the purpose of identifying qualified donees.

Once the customer is determined to be a Qualified Donee (104), the products presented for purchase are Verified (105). Product Verification (105) in general comprises the steps necessary to determine whether any of the products or services presented by the qualified donee correspond to any pending Charitable Subscription Agreements (101) and compiling the charitable distributions in the form of purchase credits associated with the Subscription Agreements (101). In a retail market, such as one selling food, apparel, toys, etc., Product Verification (105) will generally comprise the steps of Reading (106) the Universal Product Code (“UPC”) and any suffix codes code with an optical bar code reader or by manually entering the codes via an available keyboard into a POS terminal (122). Once a product UPC code is read, the POS System Controller (120) Compares (107) the UPC code of the product read with UPC code information of all the products specified in pending Charitable Donations (100). If there is at least one product Match (108), the POS System Controller (120) Determines all Applicable Charitable Distributions (109) in the form of purchase credits. This function may be performed by looking up the applicable credits on a list of purchase credits corresponding to all pending Subscription Agreements (101) residing on an appropriate database. The applicable purchase credits are then Compiled (110) in an appropriate database on the POS System Controller (120). In the event the retail establishment possesses a single POS Terminal (128), i.e., a single cash register, the steps of Comparing (107), Matching (108), Determining the Applicable Charitable Distribution (109), and Compiling Applicable Credit (110) are performed locally within the POS Terminal (128).

Product Verification (105) is repeated for all products presented. Once the last product is presented, the retailer enters an appropriate signal indicating the previous read product was the Final Product (111) presented for purchase, such as by hitting a key representing the end of the transaction on the POS Terminal (122) or (128). When all the products have been verified, i.e., the Final Product (110) has been presented, the applicable purchase credits compiled during Product Verification (105) are Totaled (112) and Applied (113) to reduce the total amount due from the qualified donee. If the qualified donee is an FSP or WIC program recipient, the total purchase credits would reduce the total due from the FSP or WIC programs. The transaction with the customer is finally complete when the customer pays the balance due if any. It is anticipated that at least one paper receipt of the transaction will be generated; preferably one for the customer and a copy for the retailer. Optionally, the data compiled during product verification may be retained in a frequent shopper database.

Alternatively, products or services presented for purchase may be read prior to determining whether the customer is a qualified donee, as shown in FIG. 2. In that instance, the customer produces the goods or services for purchase, the retailer will Read (140) and Compile (141) a list of all the products presented for purchase. The retailer will then determine whether the customer is a Qualified Donee (142). If the customer is a qualified donee, the Products are Verified (143), by Comparing the Products Read (144), Matching the Products Read (145), Determining the Applicable Credits (146), and Compiling (147) the applicable credits.

At the end of a convenient cycle, such as at the end of the day, the retailer will signal to the system that the previous customer was the Final Customer (114), such as by hitting an appropriate key on the POS Terminal (122) or (128). If the previous customer was the final customer, the credits corresponding to the charitable donations distributed for all customer transactions during the relevant cycle are Totaled for Collection (115). Generally, collection will be initiated by the retailer Transmitting an Invoice (116) to the charitable organization. The invoice is preferably in an electronic format and should contain the relevant transaction data of the distributed charitable donations necessary for the charitable organization to provide tracking and report generating capability to the donors, such as the amount of purchase credits applied to each particular subscription agreement, to each particular product, to each particular class qualified donees, etc. The transaction data from all retailers will be compiled by the charitable organization at the Charitable Organization Server (125) for access by donors.

It is anticipated that the charitable organization will provide donors with access to the compiled transaction data of their respective charitable donations via a World Wide Web (“WWW”) Site. In that instance, the Donor Interface (123) comprises any means capable of accessing a WWW site, such as though an Internet connection. Donors may track their respective donations on the charitable organization's WWW site, manipulate the data and generate reports associated sufficient to satisfy I.R.S. reporting requirements.

FIG. 3 depicts an embodiment of a system for distributing charitable donations to qualified donees at the point of sale (130). The system (130) comprises a plurality of POS Terminals (122) and (128), a Network Lan (124), a POS System Controller (120), a POS Network Controller (129), a Communications Network (127), a Charitable Organization Server (125), a Donor Interface (123), and optional Donee Interface (126). The POS Terminals (122) and (128) may further comprise an electronic cash register (“ECR”) system equipped with a combination of data input devices, such as an alphanumeric keyboard, a customer keyboard, optical scanning devices, magnetic card readers, printer, etc. The Charitable Organization Server (125), the POS System Controller (120), POS Network Controller (129), and the POS Terminals (128), each further comprising a processor and at least one database.

It is anticipated that POS Terminals (128) of System (130) would typically appear in retail establishments having a single interface, such as in a store with one register, wherein the POS Terminals (128) are connected to the Charitable Organization Server (125), Donor Interface (123) and a optional Donee Interface (126) over a Communications Network (127). The Communications Network (127) can be, but is not limited to, dial up connection, a Wide Area Network (“WAN”), or the Internet. POS Terminals (122) and corresponding Network Lan (124), POS Network Controller (129), and POS System Controller (120) would typically appear in establishments with multiple interfaces, such as for example a food market, wherein a plurality of POS Terminals (122) will be connected to a POS System Controller (120) and a POS Network Controller (129) over a Network Lan (124) and the POS System Controller (120) connected to the Charitable Organization Server (125), Donor Interface (123) and a optional Donee Interface (126) over a Communications Network (127). The optional Donee Interface (126) may be any device or system that would allow a donee to retrieve information regarding charitable distributions such as the location, the size of the purchase credit, the applicable product, etc., such as an Interactive Voice Response (“IVR”) system, a WEB TV interface, a personal computer with Internet access, or any other communication means suitable for this purpose. It is understood to those reasonable skilled in the art that the system depicted in FIG. 3 is one but one of many system arrangements that may be employed to accomplish the methods of this invention and thus the system depicted shall be viewed as merely an example and not a limitation.

The POS System Controller (120) is generally a central processing and database engine that runs all system applications, generates and updates local databases, and passively monitors all of the transactions that occur over the in-store POS Terminals (122). The POS System Controller (120) communicates over the Communication Network (127) to the relevant Charitable Organization Server (125). The POS System Controller (120) includes a processor and at least one database. To accommodate the functionality of the POS Terminals (122), the POS System Controller (120) contains databases to store relevant data such as product and coupon family code, purchase transactions, frequent shopper benefits, coupons tendered, currency exchange rates, permissible EBT (i.e., Food Stamp and WIC program recipients) users, algorithms regarding disbursements from the charity or foundation relevant to the present invention, compiled transaction data, etc.

Applications on the POS System Controller (120) generally monitor the purchases and totals accumulated in the POS Terminals (122) and/or the POS Network Controller (129). The POS System Controller (120) interprets the data received from each of the POS Terminals (122) such as from optical bar code reader, check reader, or magnetic stripe reader, keyboards, and performs the matching and compiling functions as described above. Further, the POS System Controller (120) creates transaction records and invoices for distribution to the public charity or foundation. This transaction records include details of all transactions to which purchase credits have been applied to qualified donees.

The invention has been described in an illustrative manner, and it is to be understood that the terminology that has been used is intended to be in the nature of words of description rather than of limitation. The invention may be embodied in other specific forms without departing from the spirit or essential characteristics thereof. The present embodiments are therefore to be considered in all respects as illustrative and not restrictive.

What is claimed is:

1. A method of distributing charitable donations at a point of sale comprising:
creating a subscription agreement associated with a charitable donation, the subscription agreement containing data for identifying qualified donees and covered products;
communicating the a subscription agreement to retailers;
determining, at a point of sale, whether a customer is a qualified donee;
verifying a product being purchased by the customer as being a covered product; and
applying a credit associated with the verified product at the point of sale in accordance with the subscription agreement.

2. The method of claim 1, wherein verifying at least one product comprises:
reading a product code of a product being purchased by the customer;
matching the product code with product codes of products provided for in a subscription agreement; and
determining whether there exists a purchase credit associated with the subscription agreement.

3. The method of claim 1, wherein creating a subscription agreement comprises allowing the charitable organization to dictate the manner in which the charitable donation will be distributed.

4. The method of claim 1, wherein creating a subscription agreement comprises allowing a donor to dictate a manner in which the charitable donation will be distributed.

5. The method of claim 1, wherein determining whether the customer is a qualified donee comprises determining whether the customer is a Food Stamp or WIC program participant.

6. The method of claim 1, comprising compiling data associated with distributed purchase credits in accordance the subscription agreement.

7. The method of claim 6, comprising generating an invoice.

8. The method of claim 6, comprising generating a report associated with the subscription agreement.

9. A system for distributing charitable donations at a point of sale comprising:
a donor interface configured for use by a donor to specify terms of a subscription agreement, communicate the terms of the subscription agreement to a charitable organization, and track distribution of purchase credits associates with the subscription agreement;
a charitable organization server configured to receive the terms of the subscription agreement, store the subscription agreement terms for distribution to retailers, and store data regarding distributions of charitable donations in accordance the subscription agreement; and
a point of sale terminal positioned at a location wherein a customer produces a product for purchase, configured to determine whether the customer is a qualified donee and whether the product is a covered product associated with a subscription agreement, and to provide the qualified donee with a purchase credit toward the purchase of the covered product,
wherein the point of service terminal, the charitable organization server, and the donor interface are connected over a communication network.

10. The system of claim 9, comprising a point of sale network controller.

11. The system of claim 9, comprising an interactive voice response system.

12. The system of claim 9, comprising a qualified donee interface.
